(19) United States
(12) Patent Application Publication
(10) Pub. No.: US 2010/0255253 A1
(43) Pub. Date: Oct. 7, 2010

(54) DOUBLE-SIDED PRESSURE-SENSITIVE ADHESIVE SHEET, PRODUCTION METHOD OF DOUBLE-SIDED PRESSURE-SENSITIVE ADHESIVE SHEET, PRESSURE-SENSITIVE ADHESION TYPE OPTICAL FUNCTIONAL FILM AND PRESSURE-SENSITIVE ADHESION TYPE HARD COAT FILM

(75) Inventor: Hiroaki KISHIOKA, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/751,074

(22) Filed: Mar. 31, 2010

(30) Foreign Application Priority Data
Apr. 1, 2009 (JP) 2009-089197

(51) Int. Cl. B32B 3/10

(52) U.S. Cl. 428/141; 428/172

(57) ABSTRACT

The present invention provides a double-sided pressure-sensitive adhesive sheet, which includes a pressure-sensitive adhesive layer formed from a pressure-sensitive adhesive composition that contains an acrylic polymer constituted from one or more monomer components containing a (meth) acrylic acid alkyl ester wherein the number of carbons of the alkyl group is from 1 to 12 and/or a (meth)acrylic acid alkoxyalkyl ester, in which the soluble fraction (sol fraction) obtained by ethyl acetate extraction of the pressure-sensitive adhesive layer has a weight average molecular weight of from 50,000 to 500,000, and the pressure-sensitive adhesive layer has a thickness unevenness of the whole surface of 0.030 μm or less.

### FIELD OF THE INVENTION

This invention relates to a double-sided pressure-sensitive adhesive sheet. In more detail, the invention relates to a double-sided pressure-sensitive adhesive sheet which is excellent in durability and transparency, and what is more, is also excellent in smoothing property and uniformity in thickness of the pressure-sensitive adhesive layer.

### BACKGROUND OF THE INVENTION

In recent years, especially in the field of mobile devices, such as cellular phone and a smart phone; display of television and computer; and the like, there are a large number of applications of attaching and fixing an optical film and the like to a transparent plastic base such as a polycarbonate resin plate and an acrylic resin plate by using a double-sided pressure-sensitive adhesive sheet (double-sided pressure-sensitive adhesive tape). In these applications, the double-sided pressure-sensitive adhesive sheet is required to have transparency which does not ruin visibility of a display and the like, in addition to adhesiveness and adhesion reliability (durability).

As such a double-sided pressure-sensitive adhesive sheet, for example, there is known a double-sided pressure-sensitive adhesive sheet which employs a pressure-sensitive adhesive composition constituted from an acrylic polymer (see, Japanese Patent No. 3,907,611 and JP-A-2005-255877).

However, due to a demand for miniaturization and slimization of mobile devices and the like in recent years, the aforementioned plastic base and optical film are also becoming slimized. Consequently, in the case that they are laminated with each other by using conventional pressure-sensitive adhesive sheet (pressure-sensitive adhesive layer), there has been found that a poor appearance that a surface of a display thereof looks like a “citron skin” occurs because when light is reflected on the display thereof, a mottle of the reflected light occurs.

When further examination on the above-mentioned poor appearance was carried out, it was found that a minute variation in a thickness of the pressure-sensitive adhesive layer which laminates the slimized plastic base and optical film causes a reflected light mottle and this is a main cause of the above-mentioned poor appearance.

### SUMMARY OF THE INVENTION

Accordingly, an object of the invention is to provide a double-sided pressure-sensitive adhesive sheet which is excellent in durability and transparency and is also small in the thickness unevenness of the whole surface (minute variation in the thickness of pressure-sensitive adhesive layer) of pressure-sensitive adhesive layer, thereby showing excellent appearance when laminated with a slimized plastic base or the like.

With the aim of achieving the above-mentioned object, the inventors have conducted intensive studies and found as a result that a double-sided pressure-sensitive adhesive sheet having a pressure-sensitive adhesive layer formed from a pressure-sensitive adhesive composition which contains an acrylic polymer constituted from one or more specified monomer components has excellent transparency and durability and still more, its excellent appearance at the time of lamination can be obtained even in the case of thin layer by controlling weight average molecular weight of sol fraction, and thickness unevenness of the whole surface, of the double-sided pressure-sensitive adhesive sheet, thereby accomplishing the invention.

Namely, the present invention provides the following items 1 to 14.

1. A double-sided pressure-sensitive adhesive sheet, which comprises a pressure-sensitive adhesive layer formed from a pressure-sensitive adhesive composition that contains an acrylic polymer constituted from one or more monomer components containing a (meth) acrylic acid alkyl ester wherein the number of carbons of the alkyl group is from 1 to 12 and/or a (meth)acrylic acid alkoxyalkyl ester,

wherein the soluble fraction (sol fraction) obtained by ethyl acetate extraction of the pressure-sensitive adhesive layer has a weight average molecular weight of from 50,000 to 500,000, and

wherein the pressure-sensitive adhesive layer has a thickness unevenness of the whole surface of 0.030 μm or less, the thickness unevenness of the whole surface of the pressure-sensitive adhesive layer being a value which is obtained by converting an interference fringe obtained using a laser interferometer into the thickness hᵢ of the pressure-sensitive adhesive layer in accordance with a fringe scanning method (stripe scanning method) and then making a calculation using the hᵢ value obtained in the measurement range of a diameter of 30 mm in accordance with the following formula (1):

$$( Thickness unevenness of the whole surface ) = \sqrt{\frac{\sum {h}_{i}^{2}}{N} - {( \frac{\sum {h}_{i}}{N} )}^{2}} \qquad ( 1 )$$

wherein i is an integer of from 1 to N, and N is a number of samplings.

2. The double-sided pressure-sensitive adhesive sheet according to item 1, having a total light transmittance within the visible light wavelength region of 90.0% or more.

3. The double-sided pressure-sensitive adhesive sheet according to item 1, having a haze value of 1.5% or less.

4. The double-sided pressure-sensitive adhesive sheet according to item 1, wherein the pressure-sensitive adhesive composition further contains a crosslinking agent.

5. The double-sided pressure-sensitive adhesive sheet according to item 1, wherein the total amount of the (meth) acrylic acid alkyl ester wherein the number of carbons of the alkyl group is from 1 to 12 and the (meth)acrylic acid alkoxyalkyl ester is 50% by weight or more based on the total amount of monomer components constituting the acrylic polymer.

6. The double-sided pressure-sensitive adhesive sheet according to item 1, wherein the acrylic polymer in the pressure-sensitive adhesive composition is contained in an amount of from 65 to 100% by weight based on the solid fraction of the pressure-sensitive adhesive composition.

7. The double-sided pressure-sensitive adhesive sheet according to item 1, which further comprises a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer.

8. The double-sided pressure-sensitive adhesive sheet according to item 1, which is a double-sided pressure-sensitive adhesive sheet that does not include a substrate.

9. The double-sided pressure-sensitive adhesive sheet according to item 1, which is a double-sided pressure-sensitive adhesive sheet that includes a substrate.

10. The double-sided pressure-sensitive adhesive sheet according to item 9, wherein pressure-sensitive adhesive layers are provided on both sides of the substrate having a total light transmittance within the visible light wavelength region of 85% or more and a haze value of 1.5% or less, and at least one of the pressure-sensitive adhesive layers is the pressure-sensitive adhesive layer according to item 1.

11. The double-sided pressure-sensitive adhesive sheet according to item 1, which is for use in an optical product.

12. A method for producing the double-sided pressure-sensitive adhesive sheet according to item 8, which comprises providing a coating layer of a pressure-sensitive adhesive composition on a separator, followed by drying and hardening the coating layer to form a pressure-sensitive adhesive layer.

13. A pressure-sensitive adhesive type optically functional film, which comprises:

a film having an optically functioning property; and

stuck to the film, a double-sided pressure-sensitive adhesive sheet which comprises a pressure-sensitive adhesive layer, and a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer, and the double-sided pressure-sensitive adhesive sheet has a total light transmittance within the visible light wavelength region of 90.0% or more and a haze value of 1.5% or less.

14. A pressure-sensitive adhesive type hard coat film, which comprises:

a film applied with a hard coat treatment on at least one side thereof; and

stuck to the film, a double-sided pressure-sensitive adhesive sheet which comprises a pressure-sensitive adhesive layer, and a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer, and the double-sided pressure-sensitive adhesive sheet has a total light transmittance within the visible light wavelength region of 90.0% or more and a haze value of 1.5% or less.

Since the double-sided pressure-sensitive adhesive sheet of the invention has the aforementioned construction, it is excellent in transparency and durability, and therefore when used especially in laminating slimized optical members and the like, optical characteristics such as visibility of these products can be improved. In addition, since it does not cause a reflected light mottle originated from a minute variation in thickness of the pressure-sensitive adhesive layer, the quality of products is improved without poor appearance. In this connection, according to the invention, the term “durability” means a property that floating or peeling of the pressure-sensitive adhesive sheet or an adherend does not occur (adhesion reliability) even when the adherend (optical member or the like) is laminated using the double-sided pressure-sensitive adhesive sheet and preserved under a high temperature or high temperature high moisture condition for a prolonged period of time.

### DETAILED DESCRIPTION OF THE INVENTION

The double-sided pressure-sensitive adhesive sheet of the invention is a pressure-sensitive adhesive sheet which includes at least one pressure-sensitive adhesive layer (acrylic pressure-sensitive adhesive layer, which may be referred sometimes to as “pressure-sensitive adhesive layer of the invention” hereinafter) formed from a pressure-sensitive adhesive composition that contains an acrylic polymer constituted from one or more monomer components containing a (meth) acrylic acid alkyl ester wherein the number of carbons of the alkyl group is from 1 to 12 and/or a (meth)acrylic acid alkoxyalkyl ester. In addition, the double-sided pressure-sensitive adhesive sheet of the invention is a double-sided pressure-sensitive adhesive sheet in which both sides of the sheet form a pressure-sensitive adhesive face (pressure-sensitive adhesive layer surface). In this connection, when called “pressure-sensitive adhesive sheet” in the invention, it also should include a shape of tape, namely “pressure-sensitive adhesive tape”.

### Pressure-sensitive Adhesive Composition

The above-mentioned pressure-sensitive adhesive layer of the invention is a pressure-sensitive adhesive layer (acrylic pressure-sensitive adhesive layer) formed from a pressure-sensitive adhesive composition (acrylic pressure-sensitive adhesive composition) containing the following acrylic polymer as an essential component. In addition to the acrylic polymer, other components (additive agent and the like) may be contained as occasion demands in the above-mentioned pressure-sensitive adhesive composition. In this connection, amount of the acrylic polymer to be contained in the above-mentioned pressure-sensitive adhesive composition, though not particularly limited, is preferably 65% by weight or more (e.g., from 65 to 100% by weight), more preferably from 70 to 99.999% by weight, based on the solid fraction (100% by weight) of the pressure-sensitive adhesive composition.

The above-mentioned acrylic polymer is a polymer constituted from, as the main monomer component (monomer main component), a (meth) acrylic acid alkyl ester wherein the number of carbons of the alkyl group is from 1 to 12 (to be referred sometimes to as “(meth) acrylic acid C₁₋₁₂ alkyl ester”) and/or a (meth)acrylic acid alkoxyalkyl ester. In addition, as the monomer component which constitutes the acrylic polymer, other copolymerizable monomer component (copolymerizable monomer) may be contained in addition to the above-mentioned main monomer component. In this connection, the “(meth)acrylic” means “acrylic” and/or “methacrylic”. The same shall apply hereinafter.

The above-mentioned (meth)acrylic acid C₁₋₁₂ alkyl ester is a (meth)acrylic acid alkyl ester which contains a straight chain or branched chain alkyl group having from 1 to 12 carbon atoms, and the examples thereof include methyl (meth)acrylate, ethyl (meth)acrylate, propyl (meth)acrylate, isopropyl (meth)acrylate, n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, octyl (meth)acrylate, iso-octyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, dodecyl (meth)acrylate and the like, though not particularly limited thereto. Among them, ethyl acrylate, n-butyl acrylate, 2-ethylhexyl acrylate and isononyl acrylate are desirable, and 2-ethylhexyl acrylate (2EHA) and n-butyl acrylate (BA) are particularly desirable. The above-mentioned (meth)acrylic acid C₁₋₁₂ alkyl esters can be used alone or in combination of two or more species.

As the above-mentioned (meth)acrylic acid alkoxyalkyl ester, for example, 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, 4-ethoxybutyl (meth)acrylate and the like can be mentioned, though not particularly limited thereto. Among them, acrylic acid alkoxyalkyl esters are desirable and 2-methoxyethyl acrylate (2MEA) is particularly desirable. The above-mentioned (meth)acrylic acid alkoxyalkyl esters can be used alone or in combination of two or more species.

Containing amount of the above-mentioned main monomer component [(meth)acrylic acid C₁₋₁₂ alkyl ester and/or (meth)acrylic acid alkoxyalkyl ester] based on the total monomer components constituting the acrylic polymer (total amount of monomer components) (100% by weight) is, since used as the monomer main component, preferably 50% by weight or more, more preferably 80% by weight or more, further preferably 90% by weight or more. In this connection, upper limit of the containing amount of the main monomer component based on the total amount of monomer components is not particularly limited but is preferably 99.5% by weight or less, more preferably 99% by weight or less. In this connection, in case that both of the (meth)acrylic acid C₁₋₁₂ alkyl ester and (meth)acrylic acid alkoxyalkyl ester are used as the monomer components, total amount (total content) of the (meth)acrylic acid C₁₋₁₂ alkyl ester content and the (meth)acrylic acid alkoxyalkyl ester content may satisfy the above-mentioned range.

In addition, a polar group-containing monomer, a multifunctional monomer and other copolymerizable monomer may be further contained as copolymerizable monomer components in the monomer components which constitute the above-mentioned acrylic polymer.

As the above-mentioned polar group-containing monomer, for example, there may be mentioned (meth) acrylic acid, itaconic acid, maleic acid, fumaric acid, crotonic acid, isocrotonic acid and the like carboxyl group-containing monomers or anhydrides thereof (maleic anhydride and the like); 2-hydroxyethyl (meth)acrylate, 3-hydroxypropyl (meth)acrylate, 4-hydroxybutyl (meth)acrylate, 6-hydroxyhexyl (meth)acrylate and the like hydroxyalkyl (meth)acrylate; vinyl alcohol, allyl alcohol and the like hydroxyl group-containing monomers; (meth)acrylamide, N,N-dimethyl (meth)acrylamide, N-methylol (meth)acrylamide, N-methoxymethyl (meth)acrylamide, N-butoxymethyl (meth)acrylamide, N-hydroxyethyl arylamide and the like amido group-containing monomers; aminoethyl (meth)acrylate, dimethylaminoethyl (meth)acrylate, t-butylaminoethyl (meth)acrylate and the like amino group-containing monomers; glycidyl (meth)acrylate, methylglycidyl (meth)acrylate and the like glycidyl group-containing monomers; acrylonitrile, methacrylonitrile and the like cyano group-containing monomers; N-vinyl-2-pyrrolidone and (meth)acryloylmorpholine, as well as N-vinylpyridine, N-vinylpiperidine, N-vinylpyrimidine, N-vinylpiperazine, N-vinylpyrrole, N-vinylimidazole, N-vinyloxazole and the like heterocyclic ring-containing vinyl monomers; sodium vinylsulfonate and the like sulfonate group-containing monomers; 2-hydroxyethylacryloyl phosphate and the like phosphate group-containing monomers; cyclohexyl maleimide, isopropyl maleimide and the like imido group-containing monomers; 2-methacryloyloxyethyl isocyanate and the like isocyanate group-containing monomers and the like. The above-mentioned polar group-containing monomers can be used alone or as a combination of two or more species. As the polar group-containing monomers, among the above-mentioned examples, a carboxyl group-containing monomer or an acid anhydride thereof and a hydroxyl group-containing monomer are desirable, and acrylic acid (AA), 4-hydroxybutyl acrylate (4HBA) and 2-hydroxyethyl acrylate (HEA) are particularly desirable.

Content of the above-mentioned polar group-containing monomer based on the total monomer components constituting the acrylic polymer (total amount of monomer components) (100% by weight) is preferably 15% by weight or less (e.g., from 0.01 to 15% by weight), more preferably from 0.5 to 10% by weight. When the content exceeds 15% by weight, for example, there may be a case in which adhesiveness is lowered due to too high cohesive force of the pressure-sensitive adhesive layer or a case in which crosslinking becomes too dense because the polar group becomes the crosslinking point. In addition, when the content is less than 0.01% by weight which is too small, there may be a case in which adhesiveness of the pressure-sensitive adhesive layer is lowered or a case in which the crosslinking reaction becomes extremely slow.

As the above-mentioned multifunctional monomer, for example, there may be mentioned hexanediol di(meth)acrylate, butanediol di(meth)acrylate, (poly)ethylene glycol di(meth)acrylate, (poly)propylene glycol, neopentyl glycol di(meth)acrylate, pentaerythritol di(meth)acrylate, pentaerythritol tri(meth)acrylate, dipentaerythritol hexa(meth)acrylate, trimethyloipropane tri(meth)acrylate, tetramethylolmethane tri(meth)acrylate, allyl(meth)acrylate, vinyl (meth)acrylate, divinylbenzene, epoxy acrylate, polyester acrylate, urethane acrylate and the like.

Containing amount of the above-mentioned multifunctional monomer based on total monomer components constituting the acrylic polymer (total amount of monomer components) (100% by weight) is 0.5% by weight or less (e.g., from 0 to 0.5% by weight), preferably from 0 to 0.1% by weight. When the content exceeds 0.5% by weight, for example, there is a case in which the adhesiveness is lowered.

In addition, as the copolymerizable monomer other than the above-mentioned polar base-containing monomer and multifunctional monomer (other copolymerizable monomer), for example, there may be mentioned tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate and the like (meth)acrylic acid alkyl esters wherein the number of carbons of the alkyl group is from 13 to 20; cyclopentyl (meth)acrylate, cyclohexyl (meth)acrylate, isobornyl (meth)acrylate and the like (meth)acrylic acid esters having alicyclic hydrocarbon radical, phenyl (meth)acrylate and the like (meth)acrylic acid esters having aromatic hydrocarbon radical, and the like (meth)acrylic esters other than the aforementioned (meth)acrylic acid alkyl esters, (meth)acrylic acid alkoxyalkyl esters, polar group-containing monomers and multifunctional monomers; vinyl acetate, vinyl propionate and the like vinyl esters; styrene, vinyltoluene and the like aromatic vinyl compounds; ethylene, butadiene, isoprene, isobutylene and the like olefins or dienes; vinyl alkyl ether and the like vinyl ethers; vinyl chloride and the like.

The above-mentioned acrylic polymer can be prepared by a conventionally known or commonly used method. As the polymerization method of the acrylic polymer, for example, solution polymerization, emulsion polymerization, mass polymerization, polymerization by ultraviolet ray irradiation and the like can be mentioned, of which solution polymerization is suitable from the transparency, water resistance, cost and the like point of view.

Polymerization initiator and the like which are used in carrying out polymerization of the above-mentioned acrylic polymer are not particularly limited and can be used by optionally selecting from conventionally known or commonly used ones. More illustratively, for example, 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methyl propionate) and the like azo polymerization initiators; benzoyl peroxide, t-butyl hydroperoxide, di-t-butyl peroxide, t-butyl peroxybenzoate, dicumyl peroxide, 1,1-bis(t-butylperoxy)cyclododecane and the like peroxide polymerization initiators and the like oil soluble polymerization initiators can be suitably exemplified. The polymerization initiator can be used alone or by a combination of two or more species. Amount of the polymerization initiator to be used may be a general using amount, and for example, it can be selected from a range of approximately from 0.01 to 1 part by weight based on 100 parts by weight of the total monomer components constituting the acrylic polymer.

In this connection, in the solution polymerization, various general solvents can be used. As such solvents, ethyl acetate, n-butyl acetate and the like esters; toluene, benzene and the like aromatic hydrocarbons; n-hexane, n-heptane and the like aliphatic hydrocarbons; cyclohexane, methylcyclohexane and the like alicyclic hydrocarbons; methyl ethyl ketone, methyl isobutyl ketone and the like ketones, and the like organic solvents can be mentioned. The solvents can be used alone or by a combination of two or more species.

Weight average molecular weight of the above-mentioned acrylic polymer is preferably from 500,000 to 1,200,000, more preferably from 600,000 to 1,000,000, further preferably from 600,000 to 900,000. According to the invention, when solid fraction concentration of the pressure-sensitive adhesive composition (solution) to be used in forming the pressure-sensitive adhesive layer is increased and film thickness of the coating layer (namely a layer which contains solvent) of the pressure-sensitive adhesive composition at the time of drying is thinned, thereby effecting inhibition of convection inside the coating layer at the time of drying, thickness unevenness of the whole surface of the pressure-sensitive adhesive layer can be easily reduced so that such an operation is desirable. When weight average molecular weight of the acrylic polymer becomes high, viscosity of the pressure-sensitive adhesive composition at the same solid fraction concentration becomes high in comparison with the case of low weight average molecular weight. Accordingly, when weight average molecular weight of the acrylic polymer exceeds 1,200,000, solid fraction concentration of the pressure-sensitive adhesive composition cannot be increased from the viewpoint of coating property and there will be a case in which thickness unevenness of the whole surface becomes large. On the other hand, when the weight average molecular weight is less than 500,000, weight average molecular weight of the sol fraction is reduced and there will be a case of worsening durability of the pressure-sensitive adhesive layer.

In this connection, according to the invention, weight average molecular weight (Mw) of the acrylic polymer or the sol fraction of pressure-sensitive adhesive layer which is described later can be measured by gel permeation chromatography (GPC). More illustratively, it can be calculated as polystyrene basis, using “HLC-8120GPC” (trade name, mfd. by Tosoh Corp.) as a GPC measuring device and measuring under the following GPC measuring conditions.

GPC measuring conditions

Sample concentration: 0.2% by weight (tetrahydrofuran solution)

Sample injection volume: 10 μl

Eluent: tetrahydrofuran (THF)

Flow rate (flow velocity): 0.6 ml/min Column temperature (measuring temperature): 40° C.

Column: trade name “TSKgelSuperHM-H/H4000/H300/H2000” (mfd. by Tosoh Corp.)

Detector: differential refractometer (RI)

Weight average molecular weight of the acrylic polymer can be controlled by the kind of polymerization initiator and its applying amount, temperature and period of time in carrying out polymerization, as well as monomer concentration, monomer dropping rate and the like.

It is desirable that the above-mentioned pressure-sensitive adhesive composition contains a crosslinking agent. By the use of a crosslinking agent, cohesive strength of the pressure-sensitive adhesive layer can be further increased through crosslinking of the acrylic polymer. In addition, weight average molecular weight of sol fraction of the pressure-sensitive adhesive layer can be adjusted. Conventionally known substances are broadly included in the crosslinking agent. As the crosslinking agent, a multifunctional melamine compound (melamine crosslinking agent), a multifunctional epoxy compound (epoxy crosslinking agent) and a multifunctional isocyanate compound (isocyanate crosslinking agent) are particularly desirable. Among them, an isocyanate crosslinking agent and an epoxy crosslinking agent are desirable. The crosslinking agent can be used alone or as a mixture of two or more species.

As the above-mentioned melamine crosslinking agent, for example, methylated trimethylolmelamine, butylated hexamethylolmelamine and the like can be mentioned.

As the above-mentioned isocyanate crosslinking agent, for example, 1,2-ethylene diisocyanate, 1,4-butylene diisocyanate, 1,6-hexamethylene diisocyanate and the like lower aliphatic polyisocyanates; cyclopentylene diisocyanate, cyclohexylene diisocyanate, isophorone diisocyanate, hydrogenated tolylene diisocyanate, hydrogenated xylene diisocyanate and the like aliphatic polyisocyanates; 2,4-tolylene diisocyanate, 2,6-tolylene diisocyanate, 4,4′-diphenylmethane diisocyanate, xylylene diisocyanate and the like aromatic polyisocyanates and the like can be mentioned, and in addition to these, a trimethylolpropane/tolylene diisocyanate addition product [trade name “Coronate L”, mfd. by Nippon Polyurethane Industry], a trimethylolpropane/hexamethylene diisocyanate addition product [trade name “Coronate HL”, mfd. by Nippon Polyurethane Industry] and the like can also be used.

As the above-mentioned epoxy crosslinking agent, for example, N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcin diglycidyl ester and bisphenol-S-diglycidyl ester, as well as a epoxy resin having two or more epoxy groups in its molecule, and the like can be mentioned. As an article on the market, for example, “TETRAD-C” (trade name, mfd. by Mitsubishi Gas Chemical Company, Inc.) can be used.

Amount of the above-mentioned crosslinking agent to be used is not particularly limited and is in general, for example, preferably from 0.001 to 20 parts by weight, more preferably from 0.01 to 10 parts by weight, based on 100 parts by weight of the acrylic polymer. Particularly, in case that an isocyanate crosslinking agent is used, amount of the isocyanate crosslinking agent to be used is preferably from 0.01 to 20 parts by weight, more preferably from 0.01 to 3 parts by weight, based on 100 parts by weight of the acrylic polymer. In addition, in case that an epoxy crosslinking agent is used, amount of the epoxy crosslinking agent to be used is preferably from 0.001 to 5 parts by weight, more preferably from 0.01 to 5 parts by weight, based on 100 parts by weight of the acrylic polymer.

In addition to the acrylic polymer and crosslinking agent, an ultraviolet ray absorbent, an antioxidant, a light stabilizer, an age resistor, a tackifier a plasticizer, a filler, a coloring agent (a pigment, dyestuff or the like), a surfactant, an antistatic agent and the like conventionally known additive agents and a solvent (the aforementioned organic solvent or the like) may be contained as occasion demands in the above-mentioned pressure-sensitive adhesive composition.

The above-mentioned pressure-sensitive adhesive composition can be prepared by mixing an acrylic polymer (or an acrylic polymer solution) and, as occasion demands, a crosslinking agent, solvent and other additive agents.

### Double-sided Pressure-sensitive Adhesive Sheet, Pressure-sensitive Adhesive Layer of the Invention

The double-sided pressure-sensitive adhesive sheet of the invention includes at least one pressure-sensitive adhesive layer (pressure-sensitive adhesive layer of the invention) formed from the above-mentioned pressure-sensitive adhesive composition. The double-sided pressure-sensitive adhesive sheet of the invention may be a double-sided pressure-sensitive adhesive sheet of so-called “substrate-less type” which does not include a substrate (substrate layer) (to be referred sometimes to as “substrate-less double-sided pressure-sensitive adhesive sheet hereinafter), or a double-sided pressure-sensitive adhesive sheet of a substrate-possessing type. As the above-mentioned substrate-less double-sided pressure-sensitive adhesive sheet, a double-sided pressure-sensitive adhesive sheet consisting of the above-mentioned pressure-sensitive adhesive layer of the invention alone is desirable. In addition, as the substrate-possessing type double-sided pressure-sensitive adhesive sheet, it is desirable that both sides of the substrate have the pressure-sensitive adhesive layer of the invention (a structure of “pressure-sensitive adhesive layer of the invention/substrate/pressure-sensitive adhesive layer of the invention”). However, the substrate-possessing type double-sided pressure-sensitive adhesive sheet may have a structure of “pressure-sensitive adhesive, layer of the invention/substrate/pressure-sensitive adhesive layer other than that of the invention”, so long as the effect of the invention is not impaired. Particularly, from the viewpoint of the slimization of the pressure-sensitive adhesive sheet and improvement of the transparency and the like optical characteristics, the substrate-less double-sided pressure-sensitive adhesive sheet is desirable, and more desirable is the substrate-less double-sided pressure-sensitive adhesive sheet consisting of the pressure-sensitive adhesive layer of the invention alone. In this connection, the above-mentioned term “substrate (substrate layer)” does not include a release liner (separator) which is peeled off at the time of using (at the time of applying) the pressure-sensitive adhesive sheet.

Thickness of the pressure-sensitive adhesive layer of the invention in the double-sided pressure-sensitive adhesive sheet of the invention is preferably from 3 to 25 μm, more preferably from 3 to 15 μm further preferably from 6 to 15 μm. When thickness of the pressure-sensitive adhesive layer is less than 3 μm, the pressure-sensitive adhesive layer becomes so thin that stress dispersion cannot be effected so that peeling becomes apt to occur in some cases. When the thickness exceeds 25 μm, thickness of the coating layer (pressure-sensitive adhesive layer before drying) at the time of coating and drying becomes so thick that there will be a case in which thickness unevenness of the whole surface of the pressure-sensitive adhesive layer becomes large due to influence of convention inside the coating layer. In addition, there will be a case in which it becomes disadvantageous for the slimization of a product which uses the double-sided pressure-sensitive adhesive sheet. In this connection, the pressure-sensitive adhesive layer may have a shape of either a single layer structure or laminated layer structure. In addition, in the case of a double-sided pressure-sensitive adhesive sheet having a pressure-sensitive adhesive layer on each side of a substrate, thickness of each pressure-sensitive adhesive layer may be within the above-mentioned range.

In case that the double-sided pressure-sensitive adhesive sheet of the invention is the substrate-possessing type double-sided pressure-sensitive adhesive sheet, the above-mentioned pressure-sensitive adhesive layer is arranged on the substrate. Though such a substrate is not particularly limited, for example, there may be mentioned a plastic film or sheet (plastic film substrate) composed of a plastic material such as polyethylene terephthalate (PET) or the like polyester resin; polymethyl methacrylate (PMMA) or the like acrylic resin; polycarbonate resin; triacetyl cellulose (TAC); polysulfone; polyarylate; polyimide; polyvinyl chloride; polyvinyl acetate; polyethylene, polypropylene, ethylene-propylene copolymer, trade name “ARTON” (cyclic olefin system polymer, mfd. by JSR), trade name “ZEONOR” (cyclic olefin system polymer, mfd. by Nippon Zeon) or the like olefin resin. In this connection, the above-mentioned plastic material may be used alone or by a combination of two or more species.

Though not particularly limited, it is desirable that thickness of the above-mentioned substrate is, for example, from 3 to 25 μm. In this connection, the above-mentioned substrate may be in a shape of either single layer or multiple layers. In addition, the substrate surface may be treated, for example, with an optional conventionally known or commonly used surface treatment such as corona discharge treatment, plasma treatment or the like physical treatment or under coat treatment or the like chemical treatment.

It is desirable that the above-mentioned substrate is a substrate (particularly, a plastic film material) having high transparency, and for example, total light transmittance within the visible light wavelength (in accordance with JIS K 7361) of the substrate is preferably 85% or more, more preferably 88% or more, further preferably 90% or more. In addition, haze value of the substrate (in accordance with JIS K 7136) is, for example, preferably 1.5% or less, more preferably 1.0% or less.

The double-sided pressure-sensitive adhesive sheet of the invention may have other layers (e.g., intermediate layer, under coat layer and the like) within such a range that the effect of the invention is not spoiled.

Weight average molecular weight of soluble fraction (sol fraction) (simply called “sol fraction” in some cases) from ethyl acetate extraction of the pressure-sensitive adhesive layer of the invention in the double-sided pressure-sensitive adhesive sheet of the invention is from 50,000 to 500,000, preferably from 100,000 to 500,000. When weight average molecular weight of the above-mentioned sol fraction is less than 50,000, low molecular weight components are contained in the pressure-sensitive adhesive layer in such a large amount that durability of the double-sided pressure-sensitive adhesive sheet is lowered. On the other hand, when weight average molecular weight of the sol fraction exceeds 500,000, it is necessary to increase weight average molecular weight of the acrylic polymer in the pressure-sensitive adhesive composition, and when solid fraction concentration of the pressure-sensitive adhesive composition is high, the thickness unevenness of the whole surface of the pressure-sensitive adhesive layer becomes large caused by the lowering of coating property due to high viscosity. In addition, in case that solid fraction concentration of the pressure-sensitive adhesive composition is lowered from the viewpoint of coating property, the thickness unevenness of the whole surface of the pressure-sensitive adhesive layer also becomes large due to the influence of convection inside the coating layer. The above-mentioned weight average molecular weight of sol fraction can be controlled within the above-mentioned range depending on weight average molecular weight of the acrylic polymer, kind and using amount of the crosslinking agent and the like.

The above-mentioned “weight average molecular weight of soluble fraction (sol fraction) by ethyl acetate extraction” is calculated by the following measuring, method.

### (Method for Measuring Weight Average Molecular Weight of Soluble Fraction (Sol Fraction) by Ethyl Acetate Extraction)

About 0.1 g of the pressure-sensitive adhesive layer of the invention is collected from the double-sided pressure-sensitive adhesive sheet of the invention, wrapped up using a porous tetrafluoroethylene sheet with the average pore size of 0.2 μm (trade name “NTF1122”, mfd. by NITTO DENKO CORPORATION) and then bound with a kite string.

Next, the above-mentioned pressure-sensitive adhesive layer wrapped using tetrafluoroethylene sheet and bound with kite string is put into a 50 ml capacity container filled with ethyl acetate and allowed to stand still at 23° C. for 7 days. Thereafter, the ethyl acetate solution (contains extracted sol fraction) in the container is took out and dried under a reduced pressure, and the solvent (ethyl acetate) is evaporated to obtain the sol fraction.

The above-mentioned sol fraction is dissolved in tetrahydrofuran (THF) and weight average molecular weight of the sol fraction is measured, by the aforementioned gel permeation chromatography (GPC).

From the viewpoint of exerting excellent foaming/peeling resistance, gel fraction of the pressure-sensitive adhesive layer of the invention in the double-sided pressure-sensitive adhesive sheet of the invention is preferably from 30 to 80% (% by weight), more preferably from 35 to 80%. The above-mentioned gel fraction can be calculated as the ethyl acetate insoluble fraction, illustratively, it can be calculated as the weight ratio (unit: % by weight) of insoluble fraction after 7 days of soaking in ethyl acetate at 23° C., based on the sample before soaking. The above-mentioned gel fraction can be controlled by the monomer composition of acrylic polymer, weight average molecular weight, using amount (adding amount) of the crosslinking agent in the pressure-sensitive adhesive composition, and the like. When the gel fraction is less than 30%, there will be a case in which foaming is apt to occur, and when it exceeds 80%, there will be a case in which peeling is apt to occur.

The above-mentioned gel fraction (ratio of solvent-insoluble fraction) is illustratively a value calculated for example by the following “Method for measuring gel fraction”.

(Method for Measuring Gel Fraction)

About 0.1 g of the pressure-sensitive adhesive layer of the invention is collected from the double-sided pressure-sensitive adhesive sheet of the invention, wrapped up using a porous tetrafluoroethylene sheet with the average pore size of 0.2 μm (trade name “NTF1122”, mfd. by NITTO DENKO CORPORATION) and then bound with a kite string, and its weight at that time is measured and this weight is regarded as wrapped weight.

Next, the above-mentioned product wrapped using tetrafluoroethylene sheet and bound with kite string (to be referred to as “sample”) is put into a 50 ml capacity container filled with ethyl acetate and allowed to stand still at 23° C. for 7 days. Thereafter, the sample (after ethyl acetate treatment) is took out from the container, transferred into an aluminum cup and dried in a dryer at 130° C. for 2 hours to remove ethyl acetate, and then its weight is measured and this weight is regarded as weight after soaking.

Thereafter, the gel fraction is calculated from the following formula.

Gel fraction (% by weight)=(A−B)/(C−B)×100

(In the above formula, A is weight after soaking, B is wrapped weight and C is weight before soaking.)

The thickness unevenness of the whole surface of the pressure-sensitive adhesive layer of the invention in the double-sided pressure-sensitive adhesive sheet of the invention is 0.030 μm or less, preferably 0.020 μm or less. Lower limit value of the thickness unevenness of the whole surface of the pressure-sensitive adhesive layer is not particularly limited, and 0 μm is desirable but it generally becomes 0.005 μm or more from a production point of view. The thickness unevenness of the whole surface of the pressure-sensitive adhesive layer represents minute variation in the thickness of pressure-sensitive adhesive layer, and when it is large, irregularity is notable and a distortion is formed in appearance, while smooth and even appearance is obtained when it is small. In case that a smooth thin layer body (e.g., PET film) or the like is stuck to a substrate using a double-sided pressure-sensitive adhesive sheet, when there is a minute variation in thickness in the pressure-sensitive adhesive layer of the pressure-sensitive adhesive sheet, the thin layer body to be stuck follows the aforementioned minute variation in thickness of the pressure-sensitive adhesive layer so that a minute irregularity is formed on the thin layer body surface. In the case of a display application and the like, when such a surface irregularity is present, a reflected light mottle is formed on the surface to cause a poor appearance of the product, such as a case in that the display surface looks like a citron skin. When the thickness unevenness of the whole surface of the pressure-sensitive adhesive layer is 0.030 μm or less, the above-mentioned poor appearance caused by a minute variation in thickness does not occur, which is desirable in view of the quality of the product.

The “thickness unevenness of the whole surface” according to the invention is standard deviation of the pressure-sensitive adhesive layer thickness calculated from the interference fringes obtained using a laser interferometer by a fringe scanning method (stripe scanning method) within the range of 30 mm (diameter).

Further, this is calculated illustratively by the following manner.

Firstly, the pressure-sensitive adhesive layer (pressure-sensitive adhesive layer of the invention) is measured using a laser interferometer (He—Ne laser is used), and the thus obtained interference fringes are converted into thickness h of the pressure-sensitive adhesive layer in accordance with a fringe scanning method (stripe scanning method). Within a measuring range of 30 mm φ, data hᵢ of N numbers of pressure-sensitive adhesive layer thickness (=h₁, h₂, h₃, . . . , h_{N}) (i is an integer of 1 to N) are obtained and standard deviation of the pressure-sensitive adhesive layer thickness is calculated by the following formula (1).

$$( Thickness unevenness of the whole surface ) = \sqrt{\frac{\sum {h}_{i}^{2}}{N} - {( \frac{\sum {h}_{i}}{N} )}^{2}} \qquad ( 1 )$$

In this connection, N is the number of points of the measurement (a number of sampling) and is, though not particularly limited, an optional positive number of for example from 1,000 to 50,000 (preferably from 10,000 to 50,000). In addition, the “Σ” in the formula (1) represents “the sum total of values in i=1 to N”.

It is desirable that the double-sided pressure-sensitive adhesive sheet of the invention has a high transparency. For example, the total light transmittance (in accordance with JIS K 7361) within the visible light wavelength of the double-sided pressure-sensitive adhesive sheet is preferably 90.0% or more, more preferably 91.0% or more, further preferably 92.0% or more. In addition, haze value (in accordance with JIS K 7136) of the double-sided pressure-sensitive adhesive sheet is, for example, preferably 1.5% or less, more preferably 1.0% or less. In this connection, the above-mentioned total light transmittance and haze value are numerical values measured by sticking to a slide glass (total light transmittance 91.8%, haze value 0.2%). In addition, in case that a separator is arranged on the double-sided pressure-sensitive adhesive sheet, the above-mentioned total light transmittance and haze value are values measured by peeling off the separator.

The double-sided pressure-sensitive adhesive sheet of the invention can be produced in accordance with a conventionally known and generally used double-sided pressure-sensitive adhesive sheet production method. For example, in the case of a substrate-less double-sided pressure-sensitive adhesive sheet, the double-sided pressure-sensitive adhesive sheet can be prepared by coating a pressure-sensitive adhesive composition (solution) on a separator (release liner) in such a manner that the thickness after drying becomes a predetermined thickness, thereby forming a coating layer of the aforementioned pressure-sensitive adhesive composition, and then drying the coating layer and curing it as occasion demands thereby forming a pressure-sensitive adhesive layer. In addition, another separator may also be provided on the opposite side (pressure-sensitive adhesive surface) of the side on which the above-mentioned separator was provided (namely, it may have a structure in which the pressure-sensitive adhesive layer is interposed between two sheets of separator).

In the case of a double-sided pressure-sensitive adhesive sheet having a substrate, the pressure-sensitive adhesive layer may be provided by coating and drying the pressure-sensitive adhesive composition (solution) directly on the substrate surface (direct method), or the pressure-sensitive adhesive layer may be provided on the substrate by forming the pressure-sensitive adhesive layer on a separator in the same manner as described in the above and then transferring onto (sticking with) the substrate (transfer method). In addition, a separator may be provided on the pressure-sensitive adhesive side on which the separator is not provided.

As a method for coating the pressure-sensitive adhesive composition (solution) in producing the double-sided pressure-Sensitive adhesive sheet of the invention, it is possible to use a conventionally known coating method, and a generally used coater, such as a gravure roll coater, a reverse roll coater, a kiss roll coater, a dip roll coater, a bar coater, a knife coater, a spray coater, a fountain die coater or the like, can be used.

When the double-sided pressure-sensitive adhesive sheet of the invention is produced, thickness of the coating layer (before drying) prepared by coating the pressure-sensitive adhesive composition (solution) is adjusted to preferably 60 μm or less (e.g., from 20 to 60 μm), more preferably 50 μm or less. When the coating layer thickness is thick exceeding 60 μm, there will be a case in which a strong convection occurs inside the coating layer during the coating layer drying step, a minute variation in thickness occurs in the pressure-sensitive adhesive layer (after drying) caused by this, and the thickness unevenness of the whole surface of the pressure-sensitive adhesive layer thereby becomes large.

According to the invention, in order to control thickness of the pressure-sensitive adhesive within a suitable range while thinning thickness of the coating layer as described in the above, it is desirable to increase solid fraction concentration of the pressure-sensitive adhesive composition (solution) to a certain degree. Though not particularly limited, solid fraction concentration of the pressure-sensitive adhesive composition is preferably 20% by weight or more, more preferably 23% by weight or more. When the solid fraction concentration is less than 20% by weight, it becomes necessary to relatively thicken thickness of the coating layer and convection inside the coating layer is apt to occur strongly, so that there will be a case in which thickness unevenness of the whole surface of the pressure-sensitive adhesive layer becomes large. In addition, upper limit of the solid fraction concentration is not particularly limited but, since it becomes necessary to reduce molecular weight of the acrylic polymer in order to obtain a high concentration, 50% by weight is desirable from the durability point of view.

Viscosity (23° C., rate of shear 20 rpm, BH type viscometer) of the pressure-sensitive adhesive composition to be coated in producing the double-sided pressure-sensitive adhesive sheet of the invention is preferably from 0.5 to 7.0 Pa·s, more preferably from 1.0 to 5.0 Pa·s. When viscosity of the pressure-sensitive adhesive composition is less than 0.5 Pa·s, the coating layer is apt to be disordered so that there will be a case that the thickness unevenness of the whole surface of the pressure-sensitive adhesive layer becomes large. On the other hand, when it exceeds 7.0 Pa·s, there will be a case in which the pressure-sensitive adhesive composition becomes highly viscous to cause lowering of coating property. Viscosity of the pressure-sensitive adhesive composition can be controlled by weight average molecular weight of the acrylic polymer, solid matter concentration of the pressure-sensitive adhesive composition, kind of the solvent and the like.

In the production process of the double-sided pressure-sensitive adhesive sheet of the invention (forming process of the pressure-sensitive adhesive layer of the invention), when the coating layer formed by coating the pressure-sensitive adhesive composition is dried, a drying method in which the drying is started at a relatively low temperature and then a high temperature drying is preferably carried out. In the production of a general pressure-sensitive adhesive sheet, it is general from the viewpoint of improving production efficiency that the drying is carried out within a short period of time under a temperature condition as high as possible which does not cause foaming in the coating layer, but in such a drying method, evaporation rate of the solvent is high and convection occurs strongly inside the coating layer, so that thickness unevenness of the whole surface of the pressure-sensitive adhesive layer is apt to become large. Thus, in order to reduce the thickness unevenness of the whole surface by suppressing variation in thickness of the pressure-sensitive adhesive layer while maintaining the productivity, it is effective to inhibit rapid evaporation of the solvent by carrying out the drying at a relatively low temperature at the stage of early drying where evaporation of the solvent mainly occurs, and then remove residual solvent and monomer fractions remained during the polymerization by carrying out high temperature drying. Illustrative drying conditions vary depending on the thickness of coating layer, composition and solid matter concentration of the pressure-sensitive adhesive composition and the like and therefore are not particularly limited, but for example, there may be mentioned a method in which drying is carried out at a temperature of from 20 to 80° C. (preferably from 30 to 70° C.) for a period of from 20 to 180 seconds (preferably from 30 to 120 seconds), and then the drying is further carried out at a temperature of from 90 to 180° C. (preferably from 100 to 150° C.) for a period of from 30 to 180 seconds (preferably from 30 to 120 seconds). In this connection, the drying conditions are not limited to the above-mentioned two step conditions and multiple step conditions of three steps or more may be employed.

In this connection, as the method for lowering thickness unevenness of the whole surface of the pressure-sensitive adhesive layer, in addition to the above-mentioned multiple step drying, it is possible to use a solvent having slow evaporation speed. The use of a solvent having slow evaporation speed is desirable because variation in thickness of the pressure-sensitive adhesive layer due to rapid evaporation of the solvent hardly occurs and the thickness unevenness of the whole surface can be further reduced. In addition, even in case that the drying is carried out at a relatively high temperature from the beginning of drying, variation in thickness of the pressure-sensitive adhesive layer due to rapid evaporation of the solvent hardly occurs which is desirable. As such a solvent having slow evaporation speed, for example, there may be mentioned toluene, xylene, butyl acetate, isobutyl acetate, methyl isobutyl ketone (MIBK), cyclohexanone, methylcyclohexanone and the like.

A separator (release film) may be used in the double-sided pressure-sensitive adhesive sheet of the invention in order to protect surface of the pressure-sensitive adhesive layer (pressure-sensitive adhesive surface) until use. The above-mentioned separator is peeled off when the pressure-sensitive adhesive surface protected by the separator is used (that is, when the pressure-sensitive adhesive sheet is stuck to an adherend). As the above-mentioned separator, conventionally used release paper and the like can be used and is not particularly limited, but for example, a substrate having a release treatment layer, a low adhesive substrate composed of a fluorine system polymer, a low adhesive substrate composed of a non-polar polymer and the like can be used. As the above-mentioned substrate having a release treatment layer, for example, there may be mentioned a sheet of plastic film, paper or the like surface-treated with a release-treating agent such as of a silicone system, a long chain alkyl system, a fluorine system a molybdenum sulfide system and the like. Also, as the fluorine system polymer in the above-mentioned low adhesive substrate composed of a fluorine system polymer, for example, there may be mentioned polytetrafluoroethylene, polychlorotri-fluoroethylene, polyvinyl fluoride, polyvinylidene fluoride, tetrafluoroethylene-hexafluoropropylene copolymer, chlorofluoroethylene-vinylidene fluoride copolymer and the like. In addition, as the non-polar polymer in the above-mentioned low adhesive substrate composed of a non-polar polymer, for example, an olefin system resin (e.g., polyethylene, polypropylene or the like) and the like can be mentioned. In this connection, the separator can be formed by a conventionally known or generally used method. In addition, thickness and the like of the separator are not particularly limited too.

Among the above-mentioned separators, a separator in which a release treatment layer is formed on at least one side of a substrate for release liner use can be suitably used. As such a substrate for release liner use, there may be mentioned a polyester film (polyethylene terephthalate film or the like), an olefin film (polyethylene film, polypropylene film or the like), polyvinyl chloride film, polyimide film, polyamide film (nylon film), rayon film and the like plastic substrate films (plastic films) and papers (wood-free paper, Japanese paper, kraft paper, glassine paper, synthetic paper, topcoat paper and the like), as well as multiple-layered products thereof (complexes of two layers or three layers) prepared by lamination, co-extrusion and the like, and the like. In addition, the release treatment agent which constitutes the release treatment layer is not particularly limited, and for example, a silicone release treatment agent, a fluorine release treatment agent, a long chain alkyl release treatment agent and the like can be used. The release treatment agent can be used alone or in combination of two or more species.

Moreover, desirable as the separator is a separator in which a release treatment layer is formed on at least one side of a plastic film. Arithmetic mean roughness (Ra) (in accordance with JIS B0601-2001) of the release treatment face (release treatment layer side) of the plastic film of such a separator is preferably 0.05 μm or less, more preferably 0.03 μm or less. When Ra is larger than 0.05 μm, variation in pressure-sensitive adhesive layer thickness occurs caused by irregularity of the separator surface, in forming the pressure-sensitive adhesive layer on the separator, or surface of the pressure-sensitive adhesive layer becomes rough due to transfer of irregularity of the separator during preservation of the pressure-sensitive adhesive layer by protecting it with the separator, so that thickness unevenness of the whole surface of the pressure-sensitive adhesive layer is apt to become large. In this connection, the above-mentioned separator is provided in such a manner that the surface of the release treatment layer (release treatment face) is brought into contact with the surface of the pressure-sensitive adhesive layer of the double-sided pressure-sensitive adhesive sheet.

The double-sided pressure-sensitive adhesive sheet of the invention is excellent in adhesiveness and transparency and also has good durability. In addition, since thickness unevenness of the whole surface of the pressure-sensitive adhesive layer is small, it does not cause failure in appearance such as a reflected light mottle and the like. Thus, this is suitably used in production applications of optical products. As the optical products, for example, liquid crystal display, organic EL (electro-luminescence) display, PDP (plasma display panel) and the like display devices, touch panels and the like can be mentioned. The above-mentioned display devices and touch panels are used, for example, in cellular phone, smart phone and the like mobile apparatus, television, computer and the like.

Further illustratively, for example, plastic films (particularly, various functional films and the like which are described in the following) and the like can be adhered and fixed on an adherend via the double-sided pressure-sensitive adhesive sheet of the invention. As the above-mentioned adherend, acrylic resin plate, polycarbonate resin plate and the like plastic substrates, glass, TAC film, films consisting of ARTON, ZEONOR and the like, polyethylene terephthalate (PET) film, polarizing plate, conductive film and the like optical films and the like can be mentioned, though not particularly limited thereto.

In addition, a pressure-sensitive adhesive type functional film having the pressure-sensitive adhesive layer of the invention on at least one side of a functional film can be obtained by sticking and laminating the double-sided pressure-sensitive adhesive sheet of the invention on at least one side of various functional films. For example, a pressure-sensitive adhesive type hard coat film having a pressure-sensitive adhesive layer (the pressure-sensitive adhesive layer of the invention) can be obtained by laminating the pressure-sensitive adhesive sheet of the invention on the un-hard coat-treated side of a hard coat film prepared by hard coat-treating one side of a PET film (hard coat PET film). The double-sided pressure-sensitive adhesive sheet of the invention to be used in the above-mentioned pressure-sensitive adhesive type functional film may be either a substrate-less double-sided pressure-sensitive adhesive sheet or a substrate-possessing type double-sided pressure-sensitive adhesive sheet.

As the above-mentioned functional film, there may be mentioned, for example, films having optically functional properties (polarizing property, light refracting property, light scattering property, light reflecting property, light permeability, light absorbing property, optical diffraction property, optical rotatory power, visibility and the like), films having conductive property (ITO film and the like), films having ultraviolet ray cutting property, films having hard coat property (damage resistance) and the like, though not particularly limited thereto. Further illustratively, there may be mentioned a hard coat film (a film in which a hard coat treatment was applied to at least one side of a PET film or the like plastic film), a polarizing film, a wave length plate, a phase contrast film, an optical compensation film, a brightness improving film, a light conductive plate, a reflector film, an antireflection film, a transparent conductive film (ITO film or the like), a design film, a decoration film, a surface protecting film, a prism, a color filter and the like. In this connection, the above-mentioned “plate” and “film” may also include respective plate, film, sheet and the like shapes; for example, the “polarizing film” may also include “polarizing plate” and “polarizing sheet”. In addition, the “functional film” may also include “functional plate” and “functional sheet”.

### EXAMPLES

The following describes the invention further in detail based on examples, though the invention is not restricted by these examples.

### Preparation Example 1 of Acrylic Polymer (Acrylic Polymer A)

95 parts by weight of 2-ethylhexyl acrylate (2EHA), 5 parts by weight of acrylic acid (AA), 0.2 part by weight of azobisisobutyronitrile and, as a polymerization solvent, 185.7 parts by weight of ethyl acetate were put into a separable flask and stirred for 1 hour while introducing nitrogen gas. After removing oxygen in the polymerization system in this manner, this was heated up to 63° C. and allowed to undergo the reaction for 10 hours and then the concentration was adjusted with toluene to obtain an acrylic polymer solution (to be referred sometimes to as “acrylic polymer solution A”) having a solid fraction concentration of 27% by weight. Weight average molecular weight of the acrylic polymer (to be referred sometimes to as “acrylic polymer A”) in the acrylic polymer solution A was 1,000,000.

### Preparation Example 2 of Acrylic Polymer (Acrylic Polymer B)

30 parts by weight of 2-ethylhexyl acrylate (2EHA), 69 parts by weight of 2-methoxyethyl acrylate (2MEA), 1 part by weight of 4-hydroxybutyl acrylate (4HBA), 0.2 part by weight of azobisisobutyronitrile and, as a polymerization solvent, 185.7 parts by weight of ethyl acetate were put into a separable flask and stirred for 1 hour while introducing nitrogen gas. After removing oxygen in the polymerization system in this manner, this was heated up to 63° C. and allowed to undergo the reaction for 10 hours and then the concentration was adjusted with toluene to obtain an acrylic polymer solution (to be referred sometimes to as “acrylic polymer solution B”) having a solid fraction concentration of 27% by weight. Weight average molecular weight of the acrylic polymer (to be referred sometimes to as “acrylic polymer B”) in the acrylic polymer solution B was 1,000,000.

### Preparation Example 3 of Acrylic Polymer (Acrylic Polymer C)

96 parts by weight of 2-ethylhexyl acrylate (2EHA), 4 parts by weight of acrylic acid (AA), 0.2 part by weight of azobisisobutyronitrile and, as a polymerization solvent, 66.7 parts by weight of ethyl acetate were put into a separable flask and stirred for 1 hour while introducing nitrogen gas. After removing oxygen in the polymerization system in this manner, this was heated up to 63° C. and allowed to undergo the reaction for 10 hours, while optionally adding 166.7 parts by weight of ethyl acetate dropwise, and then the concentration was adjusted with toluene to obtain an acrylic polymer solution (to be referred sometimes to as “acrylic polymer solution C”) having a solid fraction concentration of 10% by weight. Weight average molecular weight of the acrylic polymer (to be referred sometimes to as “acrylic polymer C”) in the acrylic polymer solution C was 2,000,000.

### Preparation Example 4 of Acrylic Polymer (Acrylic Polymer D)

96 parts by weight of 2-ethylhexyl acrylate (2EHA), 4 parts by weight of acrylic acid (AA), 0.4 part by weight of azobisisobutyronitrile and, as a polymerization solvent, 233 parts by weight of ethyl acetate were put into a separable flask and stirred for 1 hour while introducing nitrogen gas. After removing oxygen in the polymerization system in this manner, this was heated up to 63° C. and allowed to undergo the reaction for 10 hours and then the concentration was adjusted with toluene to obtain an acrylic polymer solution (to be referred sometimes to as “acrylic polymer solution D”) having a solid fraction concentration of 30% by weight. Weight average molecular weight of the acrylic polymer (to be referred sometimes to as “acrylic polymer D”) in the acrylic polymer solution D was 300,000.

### Inventive Example 1

A pressure-sensitive adhesive composition (solid fraction concentration: 27% by weight, viscosity: 2.2 Pa·s) was prepared by mixing the acrylic polymer solution A with 0.045 part by weight of an epoxy crosslinking agent (mfd. by Mitsubishi Gas Chemical Company, Inc., trade name “TETRAD-C”) based on 100 parts by weight of the acrylic polymer A in the solution.

A double-sided pressure-sensitive adhesive sheet (substrate-less type) was prepared by spread-coating (coating layer thickness 45 μm) the thus obtained pressure-sensitive adhesive composition (solution) to a thickness after drying (thickness of pressure-sensitive adhesive layer) of 12 μm on the release treatment side of a separator which had been prepared by applying release treatment of a silicone release treatment agent to one side of a polyethylene terephthalate film (Ra of the release treatment side: 0.025 μm, thickness: 38 μm) (mfd. by Toray Industries, Inc., trade name “Lumirror R75”), drying the coated composition by heating at 60° C. for 30 seconds and 130° C. for 1.5 minutes, and then carrying out its aging at 23° C. for 120 hours.

In addition, another separator identical to the above-mentioned separator was arranged also on the other pressure-sensitive adhesive surface opposite to the pressure-sensitive adhesive surface on which the above-mentioned separator had been arranged.

### Inventive Example 2, Inventive Examples 4 to 6 and Comparative Examples 1 to 3

As shown in Table 1, double-sided pressure-sensitive adhesive sheets (substrate-less type) were prepared in the same manner as in Inventive Example 1, by changing kind of the acrylic polymer, kind and blending amount of the crosslinking agent, viscosity of the pressure-sensitive adhesive composition, solid fraction concentration, coating thickness and the like.

In this connection, solid fraction concentration of the pressure-sensitive adhesive composition was adjusted using toluene according to the necessity.

In Table 1, blending amount of TETRAD-C (an epoxy crosslinking agent. mfd. by Mitsubishi Gas Chemical Company, Inc., trade name “TETRAD-C”) was expressed by the blending amount (part by weight) of the TETRAD-C itself (the merchandise itself) based on 100 parts by weight of the acrylic polymer. On the other hand, blending amount of Coronate L (an isocyanate crosslinking agent. mfd. by Nippon Polyurethane Industry Co., Ltd., trade name “Coronate L”, solid fraction concentration 75% by weight) was expressed by its solid matter-converted blending amount (part by weight) based on 100 parts by weight of the acrylic polymer.

### Inventive Example 3

A pressure-sensitive adhesive layer was prepared by spread-coating (coating layer thickness 37 μm) the same pressure-sensitive adhesive composition of Inventive Example 2 to a thickness after drying (thickness of pressure-sensitive adhesive layer) of 10 μm on the same separator of Inventive Example 1, drying the coated composition by heating at 60° C. for 30 seconds and 130° C. for 1.5 minutes, and then carrying out its aging at 23° C. for 120 hours.

A double-sided pressure-sensitive adhesive sheet (substrate-possessing type) was prepared by transferring the pressure-sensitive adhesive layer obtained in the above onto one side of a PET film of 25 μm in thickness (total light transmittance 90.2%, haze value 0.8%) and further transferring the pressure-sensitive adhesive layer onto the other side in the same manner. Thickness of the pressure-sensitive adhesive layer is 10 μm for each side.

### Evaluation

Using the double-sided pressure-sensitive adhesive sheets obtained in Inventive

Examples and Comparative Examples, thickness unevenness of the whole surface of the pressure-sensitive adhesive layer, durability, laminated appearance, total light transmittance and haze value were evaluated by the following measuring methods or evaluation methods. In this connection, weight average molecular weight of sol fraction of the pressure-sensitive adhesive layer was measured by the aforementioned method of “weight average molecular weight of soluble fraction (sol fraction) by ethyl acetate extraction”.

The evaluation results are shown in Table 1.

### (1) Thickness Unevenness of the Whole Surface of Pressure-sensitive Adhesive Layer

This was measured using a laser interferometer “F601 (plane measurement)” manufactured by Fujinon Corporation, at diagonal 45° in a sample shape of PET separator/pressure-sensitive adhesive layer/PET separator and analyzed using an interference fringe analyzer “Al” manufactured by Fujinon Corporation, and the “RMS value” was used as the thickness unevenness of the whole surface.

Measuring field of view: 30 mmφ
The number of samplings (N): 35,235 points
Mode of analysis: SOFT mode

### (2) Durability

A laminated sample was prepared by laminating a PET film having a thickness of 125 μm (mfd. by TOYOBO CO., LTD., trade name “A4300”, size: 100 mm in length×100 mm in width) on a glass plate (mfd. by Matsunami Glass Ltd., 1 mm in thickness, size: 100 mm in length×100 mm in width) using a double-sided pressure-sensitive adhesive sheet (size: 100 mm in length×100 mm in width).

Using the laminated sample prepared in the above-described manner, tests were carried out under two conditions (85° C. treatment and 60° C. 95% RH treatment).

### (85° C. Treatment)

The above-mentioned laminated sample was subjected to 24 hours of aging at room temperature (23° C.) and then treated under a condition of 85° C. for 240 hours.

### (60° C. 95% RH Treatment)

The above-mentioned laminated sample was subjected to 24 hours of aging at room temperature (23° C.) and then treated under a condition of 60° C., 95% RH for 240 hours.

After the above-mentioned treatments, changes in appearance of the above-mentioned laminated sample were observed with the naked eye. In each case of the 85° C. treatment and 60° C. 95% RH treatment, the durability was evaluated as “good” when there were no changes in peeling, floating and the like. When changes in peeling, floating and the like were observed even in the case of only 85° C. treatment or 60° C. 95% RH treatment, the durability was evaluated as “poor”.

In this connection, Comparative Example 3 caused changes in peeling and floating under both conditions of 85° C. treatment and 60° C. 95% RH treatment.

### (3) Total Light Transmittance and Haze Value

A test piece having a layer constitution of pressure-sensitive adhesive layer/slide glass was prepared by laminating one pressure-sensitive adhesive side of each of the double-sided pressure-sensitive adhesive sheets obtained in Inventive Examples and Comparative Examples on a slide glass (mfd. by Matsunami Glass Ltd., trade name “S-1111”) and separating the separator from the other pressure-sensitive adhesive side, and measured using a haze meter (mfd. by Murakami Color Research Laboratory Co., Ltd, “HM-150”). In this connection, the haze value (%) was calculated making use of the formula of “diffusion transmittance/total light transmittance×100”.

In this connection, this was measured as such without using a slide glass in the case of a substrate film.

In the case of the substrate-possessing type double-sided pressure-sensitive adhesive sheet (Inventive Example 3), the “pressure-sensitive adhesive layer” in the above-mentioned layer constitution may be changed to “pressure-sensitive adhesive layer/substrate/pressure-sensitive adhesive layer”.

### (4) Laminated Appearance

One pressure-sensitive adhesive side of each of the double-sided pressure-sensitive adhesive sheets obtained in Inventive Examples and Comparative Examples 20 was laminated on a soda lime glass (mfd. by Matsunami Glass Ltd., article number S, thickness 1.0 mm) and an aluminum deposition polyester film (mfd. by Toray Industries, Inc., “Metalumy”) was laminated on the other pressure-sensitive adhesive side. By observing light of a fluorescent lamp reflecting from the soda lime glass side, a case in which the reflected image can be seen without distortion was judged as good laminated appearance (good), and a case in which it can be seen with distortion as poor laminated appearance (poor).

TABLE 1

| | | | Inv. Ex. 1 | Inv. Ex. 2 | Inv. Ex. 3 | Inv. Ex. 4 | Inv. Ex. 5 | Inv. Ex. 6 |
|---|---|---|---|---|---|---|---|---|
| Pressure- | Acrylic polymer | Kinds | Acrylic | Acrylic | Acrylic | Acrylic | Acrylic | Acrylic |
| sensitive | | | polymer A | polymer B | polymer B | polymer B | polymer B | polymer B |
| adhesive | | Blended amount | 100 | 100 | 100 | 100 | 100 | 100 |
| composition | | (parts by weight) | | | | | | |
| | Crosslinking agent | kinds | TETRAD C | Coronate L | Coronate L | Coronate L | Coronate L | Coronate L |
| | | Blended amount | 0.045 | 0.2 | 0.2 | 0.35 | 0.27 | 0.13 |
| | | (parts by weight) | | | | | | |
| | Solid concentration | (Weight %) | 27 | 27 | 27 | 27 | 27 | 27 |
| | Viscosity | (Pa · s) | 2.2 | 3.0 | 3.0 | 3.0 | 3.0 | 3.0 |
| | Coat layer thickness | (μm) | 45 | 45 | 37 | 45 | 45 | 45 |
| Separator | Ra | (μm) | 0.025 | 0.025 | 0.025 | 0.025 | 0.025 | 0.025 |
| Substrate | Presence of substrate | | None | None | Present | None | None | None |
| | Total light transmittance | (%) | — | — | 90.2 | — | — | — |
| | Haze | (%) | — | — | 0.8 | — | — | — |

| | | | | | | | |
|---|---|---|---|---|---|---|---|
| Thickness of pressure-Sensitive | (μm) | 12 | 12 | 10 (both | 12 | 12 | 12 |
| adhesive layer | | | | sides) | | | |

| | | | | | | | |
|---|---|---|---|---|---|---|---|
| Evaluation | Thickness unevenness of the whole surface of | 0.014 | 0.014 | 0.025 | 0.014 | 0.014 | 0.014 |
| results | pressure-sensitive adhesive layer (μm) | | | | | | |
| | Weight average molecular weight (Mw) of sol | 250,000 | 270,000 | 270,000 | 100,000 | 150,000 | 400,000 |
| | fraction of pressure-sensitive adhesive layer | | | | | | |
| | Durability (PET/glass) | good | good | good | good | good | good |
| | Laminated appearance | good | good | good | good | good | good |
| | Total light transmittance (%) | 9220 | 92.20 | 91.20 | 92.20 | 92.20 | 92.20 |
| | Haze (%) | 0.3 | 0.3 | 0.9 | 0.3 | 0.3 | 0.3 |

| | | | Comp. Ex. 1 | Comp. Ex. 2 | Comp. Ex. 3 |
|---|---|---|---|---|---|
| Pressure- | Acrylic polymer | Kinds | Acrylic | Acrylic | Acrylic |
| sensitive | | | polymer C | polymer A | polymer D |
| adhesive | | Blended amount | 100 | 100 | 100 |
| composition | | (parts by weight) | | | |
| | Crosslinking agent | kinds | Coronate L | TETRAD C | Coronate L |
| | | Blended amount | 0.07 | 0.045 | 2.0 |
| | | (parts by weight) | | | |
| | Solid concentration | (Weight %) | 10 | 15 | 30 |
| | Viscosity | (Pa · s) | 3.5 | 0.2 | 1.0 |
| | Coat layer thickness | (μm) | 120 | 80 | 40 |
| Separator | Ra | (μm) | 0.025 | 0.025 | 0.025 |
| Substrate | Presence of substrate | | None | None | None |
| | Total light transmittance | (%) | — | — | — |
| | Haze | (%) | — | — | — |

| | | | | |
|---|---|---|---|---|
| Thickness of pressure-Sensitive | (μm) | 12 | 12 | 12 |
| adhesive layer | | | | |

| | | | | |
|---|---|---|---|---|
| Evaluation results | Thickness unevenness of the whole surface of | 0.033 | 0.032 | 0.014 |
| | pressure-sensitive adhesive layer (μm) | | | |
| | Weight average molecular weight (Mw) of sol | 570,000 | 250,000 | 40,000 |
| | fraction of pressure-sensitive adhesive layer | | | |
| | Durability (PET/glass) | good | good | poor |
| | Laminated appearance | poor | poor | good |
| | Total light transmittance (%) | 92.20 | 92.20 | 92.20 |
| | Haze (%) | 0.3 | 0.3 | 0.3 |

As is evident from the results of Table 1, the double-sided pressure-sensitive adhesive sheet of the invention (Inventive Examples) is excellent in transparency and durability. Further, its laminated appearance is good. On the other hand, the laminated appearance is lowered when thickness unevenness of the whole surface of pressure-sensitive adhesive layer is large (Comparative Examples 1 and 2). In addition, the durability is lowered when weight average molecular weight of the sol fraction of pressure-sensitive adhesive layer is small (Comparative Example 3).

While the present invention has been described in detail and with reference to specific embodiments thereof, it will be apparent to one skilled in the art that various changes and modifications can be made therein without departing from the scope thereof.

This application is based on Japanese patent application No. 2009-089197 filed Apr. 1, 2009, the entire contents thereof being hereby incorporated by reference.

What is claimed is:

1. A double-sided pressure-sensitive adhesive sheet, which comprises a pressure-sensitive adhesive layer formed from a pressure-sensitive adhesive composition that contains an acrylic polymer constituted from one or more monomer components containing a (meth) acrylic acid alkyl ester wherein the number of carbons of the alkyl group is from 1 to 12 and/or a (meth)acrylic acid alkoxyalkyl ester,
wherein the soluble fraction (sol fraction) obtained by ethyl acetate extraction of the pressure-sensitive adhesive layer has a weight average molecular weight of from 50,000 to 500,000, and
wherein the pressure-sensitive adhesive layer has a thickness unevenness of the whole surface of 0.030 μm or less, the thickness unevenness of the whole surface of the pressure-sensitive adhesive layer being a value which is obtained by converting an interference fringe obtained using a laser interferometer into the thickness hᵢ of the pressure-sensitive adhesive layer in accordance with a fringe scanning method (stripe scanning method) and then making a calculation using the hᵢ value obtained in the measurement range of a diameter of 30 mm in accordance with the following formula (1):
$$( Thickness unevenness of the whole surface ) = \sqrt{\frac{\sum {h}_{i}^{2}}{N} - {( \frac{\sum {h}_{i}}{N} )}^{2}} \qquad ( 1 )$$
wherein i is an integer of from 1 to N, and N is a number of samplings.

2. The double-sided pressure-sensitive adhesive sheet according to claim 1, having a total light transmittance within the visible light wavelength region of 90.0% or more.

3. The double-sided pressure-sensitive adhesive sheet according to claim 1, having a haze value of 1.5% or less.

4. The double-sided pressure-sensitive adhesive sheet according to claim 1, wherein the pressure-sensitive adhesive composition further contains a crosslinking agent.

5. The double-sided pressure-sensitive adhesive sheet according to claim 1, wherein the total amount of the (meth) acrylic acid alkyl ester wherein the number of carbons of the alkyl group is from 1 to 12 and the (meth)acrylic acid alkoxyalkyl ester is 50% by weight or more based on the total amount of monomer components constituting the acrylic polymer.

6. The double-sided pressure-sensitive adhesive sheet according to claim 1, wherein the acrylic polymer in the pressure-sensitive adhesive composition is contained in an amount of from 65 to 100% by weight based on the solid fraction of the pressure-sensitive adhesive composition.

7. The double-sided pressure-sensitive adhesive sheet according to claim 1, which further comprises a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer.

8. The double-sided pressure-sensitive adhesive sheet according to claim 1, which is a double-sided pressure-sensitive adhesive sheet that does not include a substrate.

9. The double-sided pressure-sensitive adhesive sheet according to claim 1, which is a double-sided pressure-sensitive adhesive sheet that includes a substrate.

10. The double-sided pressure-sensitive adhesive sheet according to claim 9, wherein pressure-sensitive adhesive layers are provided on both sides of the substrate having a total light transmittance within the visible light wavelength region of 85% or more and a haze value of 1.5% or less, and at least one of the pressure-sensitive adhesive layers is the pressure-sensitive adhesive layer according to claim 1.

11. The double-sided pressure-sensitive adhesive sheet according to claim 1, which is for use in an optical product.

12. A method for producing the double-sided pressure-sensitive adhesive sheet according to claim 8, which comprises providing a coating layer of a pressure-sensitive adhesive composition on a separator, followed by drying and hardening the coating layer to form a pressure-sensitive adhesive layer.

13. A pressure-sensitive adhesive type optically functional film, which comprises:
a film having an optically functioning property; and
stuck to the film, a double-sided pressure-sensitive adhesive sheet which comprises a pressure-sensitive adhesive layer, and a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer, and the double-sided pressure-sensitive adhesive sheet has a total light transmittance within the visible light wavelength region of 90.0% or more and a haze value of 1.5% or less.

14. A pressure-sensitive adhesive type hard coat film, which comprises:
a film applied with a hard coat treatment on at least one side thereof; and
stuck to the film, a double-sided pressure-sensitive adhesive sheet which comprises a pressure-sensitive adhesive layer, and a separator comprising a plastic film and a release treatment layer formed on at least one side of the plastic film, the plastic film having an arithmetic mean roughness (Ra) of 0.05 μm or less on the release treatment layer side, wherein the separator is provided on at least one surface of the pressure-sensitive adhesive sheet in such a way that the release treatment layer is brought into contact with a surface of the pressure-sensitive adhesive layer, and the double-sided pressure-sensitive adhesive sheet has a total light transmittance within the visible light wavelength region of 90.0% or more and a haze value of 1.5% or less.
